(19) United States
(12) Patent Application Publication
(10) Pub. No.: US 2005/0051225 A1
(43) Pub. Date: Mar. 10, 2005

(54) Extension for a passageway

(76) Inventors: Thomas Monden, Stetten (DE); Manfred Klein, Kaufering (DE)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/932,448

(22) Filed: Sep. 2, 2004

(30) Foreign Application Priority Data
Sep. 4, 2003 (DE) 103 40 661.1

(51) Int. Cl. F16L 9/18; F16L 11/00; B31F 1/00

(52) U.S. Cl. 138/114

(57) ABSTRACT

An extension (1) for a pipe section (3) integrally pourable in a ceiling (2) for bridging a difference (E) between a length (L) of the pipe section (3) and a thickness (D) of the completed ceiling (2) comprises a flat material (6) and a fastening element (7) and three closure elements (8) formed as adhesive strips. By means of the fastening element (7) the extension (1) is fastened in the region of the free end (9) of the pipe section (3) and the flat material (6) coiled or wound along the periphery of the pipe section (3). The free end of the flat material (6) is then securely adhered by means of the closure elements (8) on the flat material (6).

### TECHNICAL FIELD

The invention relates to an extension for a unit integrally pourable in a structural component for creating a passageway for pipes, cables and the like, in particular for creating an extension for a pipe section integrally pourable in a component, for bridging between a length of the unit and a thickness of the completed erected structural component. Further, the invention relates to a process for forming such an extension.

### PRIOR ART

In the planning and construction of buildings passageways are frequently cut out in walls, floors and ceilings, through which, only in a later phase of construction or in an expansion project, pipes, cables and the like are passed through. In this fashion, pipes, cables and the like are prevented from sustaining damage in early phases of construction. For example, in order to create a through passageway in a concrete ceiling, a box-shaped or pipe-shaped assembly is fastened during the form work as a placeholder on the formwork and then. integrally pour the ceiling. The assembly remains in the ceiling and protrudes from the concrete ceiling usually on at least one side, whereby penetration of concrete into the passageway is generally prevented. In this case, the assembly must not protrude too far from the edge of the structural part, such that other extension work, for example the application of floor covering or installation of insulation, is hampered.

For a box-shaped assembly for creating a passageway having a polygonal profile, for example, the assembly is fabricated on the construction site using form lumber in accordance with the desired profile dimensions and the thickness of the component to be constructed. This solution is obviously flexible in its execution but is costly in terms of time and personnel. In order to reduce these costs, pre-fabricated box-shaped assemblies are well-known to the specialist, which are arranged on or adjacent to the formwork of the structural part. For different dimensions of the passageways to be constructed and for different ceiling thicknesses a plurality of embodiments of this box-shaped assembly is required.

Moreover, pipe sections having inside diameters and a length are well-known to the specialist for creating a tubular passage, which correspond to the outside diameters of the pipes, cables or the like to be passed through as well as to the thickness of the structural part to be constructed. If one considers that, depending on the country, in a given nominal diameter the effective outside diameter of the pipes differ from each other, it is immediately obvious, that a great number of assemblies for constructing tubular passageways are required having respective different inside diameters.

In WO 03/006865 A1, an assembly configured as a fire protection sleeve for creating a passageway is disclosed, which has a plurality of removable rings along an intentional break region on a cylindrical section. From this basic type having a certain inside diameter, the corresponding number of rings are broken away, until the length of the fire protection sleeve corresponds approximately to the thickness of the structural part to be constructed. For structural thicknesses, which are greater than the length of the basic type of fire protection sleeve, a hollow cylindrical supplementary adapter can be provided on the free end of the cylindrical section for bridging the difference. The drawback in this known solution is that the configuration of the cylindrical section of the fire protection sleeve represents a considerable manufacturing and cost expenditure. Even the supplemental adapter requires an additional manufacturing expense as well as in logistics. In addition, a number of configurations must be prepared for the user's use having different inside diameters.

In U.S. Pat. No. 6,062,267 a tubular assembly is disclosed, which has a first pipe section and a telescoping second pipe section arranged in the first pipe section. This passage has a specific inside diameter and can be used in different structural parts and different structural thicknesses for creating a tubular passageway. The drawback in this solution is that for different outside diameters, for example of the pipe to be passed through, different configurations of this assembly are required. In addition, the area of application of the assembly is limited by the length of the two pipe sections.

### STATEMENT OF THE INVENTION

The object of the invention is to provide an extension for assemblies integrally pourable in a structural part for creating passageways with different contours, which can be simply constructed and can be used in different structural thicknesses. In addition, the extension is considered to be economical to manufacture.

According to the invention, the extension comprises a sheet of flat material, at least one fastener element and at least one closure element.

By means of the at least one fastening element the flat material can be fastened to the free end of the unit facing away from the framework for creating a passageway and can be led along the periphery of the unit. By means of the at least one closure element the flat material can be closed to form a polygonal or tubular body. The dimensions of the flat material are determined on the one hand by the projection dimensions of the unit to be extended and on the other hand by the difference to be bridged between the free end of the unit and the thickness of the structural part. The configuration of the project per se has no substantial affect on the extension according to the invention. The assembly can, for example, have a polygonal or circular as well as an oval shape.

Frequently, the known units have a termination, or a cover. This termination or this cover can be arranged in accordance with the arrangement of the extension according to the invention on the free end of the extension, whereby the extension is additionally reinforced at the free end.

Preferably, the extension can be arranged on a fire protection sleeve. The passageways set up can, in the event of fire, represent a hazard with respect to spread of a fire. To prevent the spread of a fire through the passageway for a predetermined minimum time, the fire protection sleeve includes at least one tubular section as well as a holder for an intumescent mass, for example, in the event of fire, which upon expansion thereof, seals off the passageway. Using the extension according to the invention, a standardized fire prevention sleeve can also be arranged in structural parts, which have a greater thickness than the length of the fire protection sleeve.

Preferably, the flat material expands into an essentially rectangular shape. With a rectangular configuration, the extension led along the periphery of the unit along the thickness of the structural part has a constant rigidity. In another embodiment, the flat material forms a trapezoidal area. The shorter side of the trapezoidal area is arranged preferably at the free end of the unit. Since the longer side of the trapezoidal area comes to lie at the free end of the extension, in this region there is a larger overlapping of the flat material available than in the zone of the free end of the assembly, whereby the extension has a greater rigidity at the free end.

The flat material has advantageously a material thickness in the range of 0.1 mm to 1.5 mm. Preferably the material thickness of the flat material is in the range of 0.5 mm to 1.0 mm. The material thickness determines on the one hand, by virtue of the deformability of the flat material, an-arrangement along the periphery of the assembly and determines on the other hand the stiffness or stability of the installed extension. The greater the distance to be bridged between the free end of the assembly and the thickness of the structural part, the preferably greater the material thickness of the flat material is selected. The possibility of cutting the flat material to a desired length on site has a further influence on the material thickness of the flat material. Along with the prefabricated extensions, the flat material can, for example, be provided rolled up and prior to installation the extension can be provided with the at least one fastener element as well as the at least one closure element. If the flat material is cut to length in the desired shape on site, for example, several flat material sections can be laid over each other and simultaneously cut to the desired dimensions.

Preferably, the flat material is made of a plastics foil. The plastics foil is characterized in particular by its deformability. In addition, the most varied plastics are known, which have high rigidity with low material thickness. In one variant thereof, a metal foil is used in the manufacture of the flat material.

Preferably, the flat material is provided with stiffener elements. By means of the stiffener elements, even in the case of bridging a large difference between the free end of the unit and the thickness of the structural part the formal stability of the extension can be assured. The stiffening elements are formed, for example, as ribs or stiffening corrugations on the flat material. In another variation thereof, the flat material has both ribs and thickened corrugations as reinforcing elements.

Preferably the at least one fastening element and/or the at least one closure element is configured as adhesive strips. Preferably the adhesive strips are provided with a protective foil, which is removed prior to utilization of the fastening elements and/or the closure elements. The at least one fastening element arranged on the flat material is adhered to an area of the free end of the unit. Afterwards, the flat material is led along the periphery of the unit, the protective foil on the at least one closure element is removed and the overlapping zone of the flat material is securely adhered to the flat material. In one variant thereof, the at least one closure element is configured as a hook-and-loop closure part, which can be joined together with a correspondingly configured complementary part on the flat material.

Advantageously, the flat material is provided with a measurement device, optionally with a measurement grid. The measuring device is, for example, formed as an imprinted or glued-on calibrated straight-edge. If the flat material is provided with a measurement grid, the grid can not only be cut precisely to length perpendicularly to the measuring device but also in the direction running parallel thereto. The measuring device or the measurement grid on the flat material has for the European region preferably a metric scale and for the Anglo-American region a scale in inches or a fractional measurement thereof. Thus, the extension according to the invention can be used worldwide.

Other advantageous embodiments and combinations of features of the invention will become apparent from the following detailed description and the set of patent claims.

### BRIEF DESCRIPTION OF THE DRAWINGS

The invention will be explained below in more detail using several exemplary embodiments. Wherein:

FIGS. 1a, 1b each represent a view of a first exemplary embodiment of a pipe extension according to the invention in the partially installed and in the installed condition;

FIG. 2 represents a view of a second exemplary embodiment as an extension for a fire protection sleeve;

FIG. 3 represents a perspective representation upon a further exemplary embodiment of the extension according to the invention arranged on a rectangular passageway;

FIG. 4 represents a view of an extension provided with reinforcing elements;

FIG. 5 represents a section through the flat material of the extension along the line V-V in FIG. 4, and FIG. 6 represents a view upon a further exemplary embodiment of the extension according to the invention with a measuring device.

In principle, identical parts in the Figures are provided with the same reference numbers.

### DETAILED DESCRIPTION OF THE INVENTION

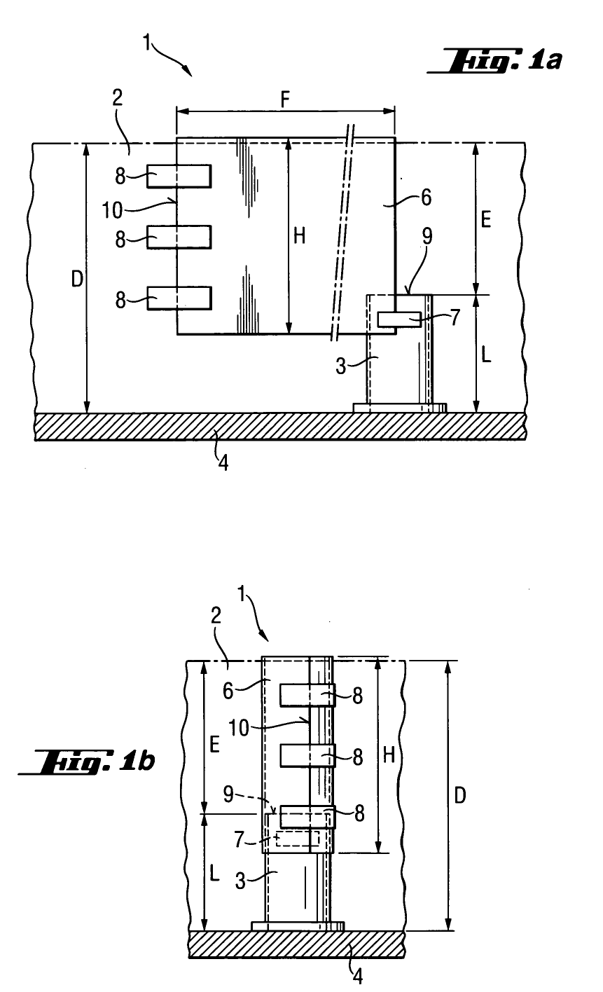

FIG. 1a represents a view of a first exemplary embodiment of a pipe extension according to the invention in the partially installed condition and in FIG. 1b in the installed condition. For later installation of a pipeline through a ceiling 2, a pipe passage 3 for creating a passageway is fastened on a formwork 4. An extension 1 is arranged on the pipe passage 3 for bridging the difference E between the length L of the pipe passage 3 and the thickness D of the ceiling 2.

The extension 1 comprises a flexible flat material 6 made of a plastics on which a fastening element 7 is placed as an adhesive strip and three closure elements 8 also formed as adhesive strips are arranged. The flat material 6 is fastened by means of the fastening element 7 in the region of the free end 9 of the pipe passage 3. Then, the flat material 6 is wound about the free end 9 of the pipe passage 3. Depending on the length F of the flat material 6 and the periphery of the pipe passage 3, the extension has several layers in the installed condition. The free end 10 of the flat material 6 is adhesively attached by means of the closure elements 8 to the flat material 6. The width H of the flat material 6 is selected, so that the extension 1 in the installed conditions slightly overlaps the upper edge of the finished ceiling 2.

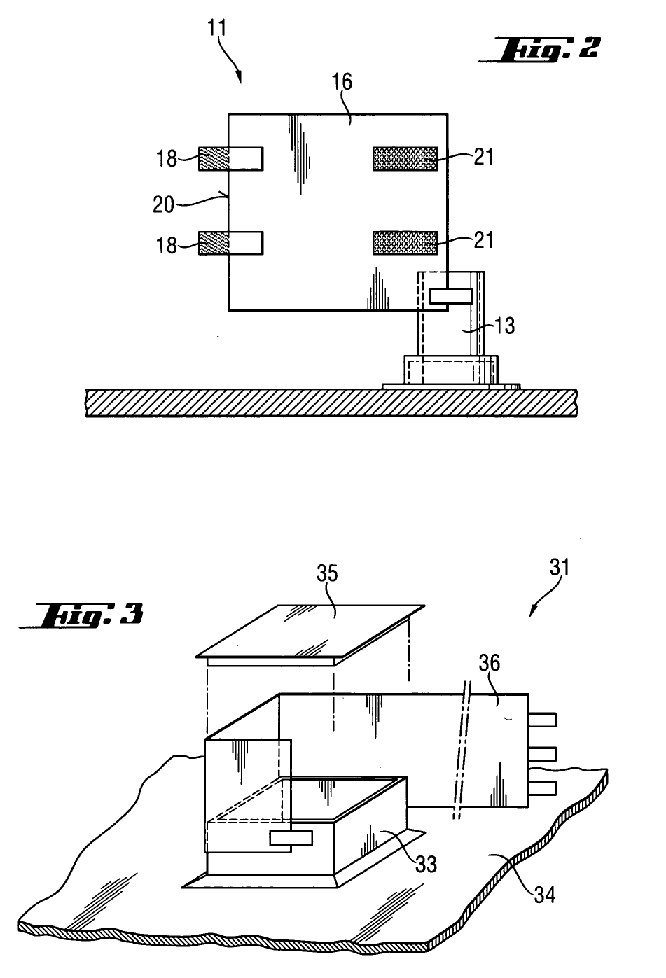

The extension 11 represented in FIG. 2 for a fire protection sleeve 13 has, in contrast with the extension 1 described in FIG. 1a and FIG. 1b, two closure elements 18 configured as hook-in-loop [Velcro] closures. Complementary elements 21, on which the closure elements 18 engage, are arranged on the flat material 16 for fastening of the free edge 20.

A box element 33 arranged on a framework 34 for creating a rectangular passage with a variant according to the invention of the extensions previously described is represented in FIG. 3. The flat material 36 is led along the periphery of the box element 33 and then the overlapping zone securely adhesively bonded to the flat material 36. A cover 35 is placed on the extension 31 for stabilizing the extension 31 in the installed condition. The cover 35 prevents in addition the penetration of material during the construction phase into the passageway created by the box element 33.

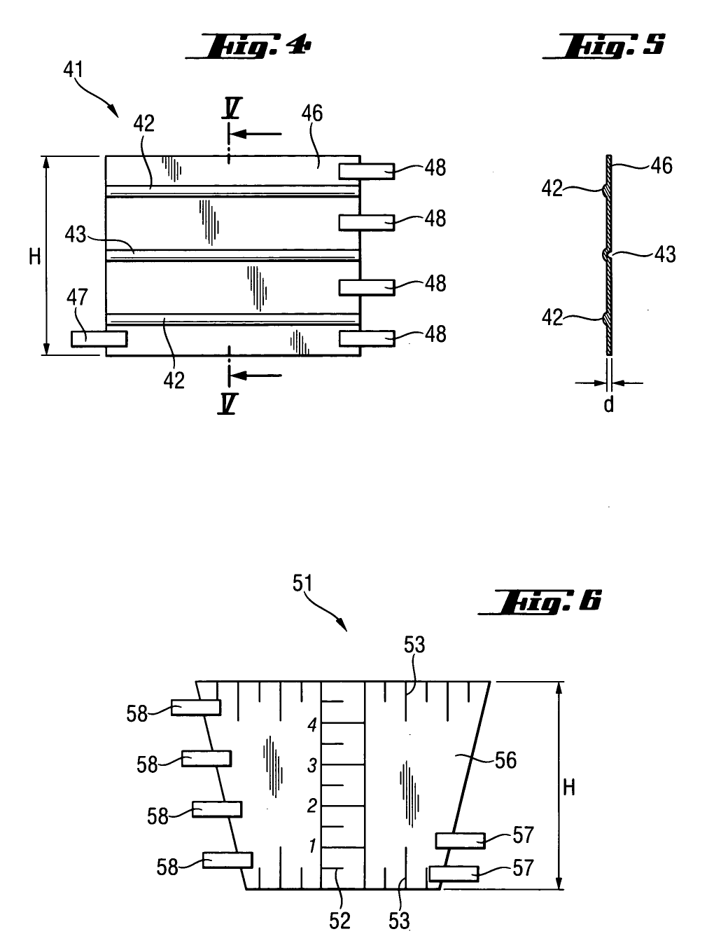

The flat material 46 of the extensional in accordance with FIG. 4 and FIG. 5 is provided with ribs 42 and a stiffening corrugation 43 as stiffening elements, which are arranged transverse to the width H of the extension 41. In addition, the extension 41 has a fastening element 47 and four closure elements 48. The material thickness d of the flat material 46 fabricated out of plastics film is 0.8 mm in this exemplary embodiment.

A view upon a further exemplary embodiment of the extension according to the invention equipped with a measurement device is represented in FIG. 6. The flat material 56 of the extension 51 forms a trapezoidal area and is provided with two fastening elements 57 and with four closure elements 58. In addition, the flat material 56 has a measurement scale 52 running in the direction of the width H as well as to additional measurement scales 53 running transversely thereof.

1. An extension for a unit (33) integrally formed in a structural part (2) for forming a passageway for pipes, cables and the like such as an extension of a pipe section and the like integrally poured in the structural part (2) for bridging a difference (E) between a length (L) of a unit (3, 13, 33) extending into the structural part and a thickness (D) of the completed structural part (2) wherein the extension (1, 11, 31, 41, 51) comprises a sheet of flat material having a first end and a second end to the formed in the shape of the unit (3, 13, 33) and to extend the unit, at least one fastening element (7, 47, 57) for attachment of the first end of said flat material to each unit (3, 12, 33) and at least one closure element for attachment of the second end of said flat material to said flat material.

2. An extension, as set forth in claim 1, wherein said extension (11) can be arranged on a unit in the form of a fire protection sleeve (13).

3. An extension, as set forth in claim 1, wherein said flat material is formed as an essentially rectangular shaped said unit.

4. An extension, as set forth in claim 1, wherein the flat material (6; 16; 36; 46; 56) has a material thickness (d) in the range of 0.1 mm to 1.5 mm.

5. An extension, as set forth in claim 4, wherein the flat material has a thickness in the range of 0.5 mm to 1.0 mm.

6. An extension, as set forth in claim 1, wherein the flat material (6, 16, 36, 46, 56) is formed of a plastics foil.

7. An extension, as set forth in claims 1, wherein said flat material (46) has stiffening elements extending in the direction between said first and second ends.

8. An extension, as set forth in claims 7, wherein said stiffening elements are formed of at least one of ribs (44) and stiffening corrugations.

9. An extension, as set forth in claim 1, wherein said at least one fastening element (7, 47, 57) and said at least one closure element (18, 48, 58) are formed as adhesive strips.

10. An extension, as set forth in claim 1, wherein said flat material is provided with a measuring device (52) extending generally in the direction of said first and second ends.

11. An extension, as set forth in claim 1, wherein said flat material is provided with a measuring device (53) extending in the direction between said first and second ends.

12. A method of forming an extension for a unit integrally poured in a structural part for forming a passageway for pipes, cables and the like such as an extension of a pipe section integrally poured in the structural part for bridging a difference (E) between a length (L) of the unit extending into the structural part and a thickness (D) of the completed structural part (2) comprising the steps of forming a sheet of flexible flat material having a first and second end spaced apart and spaced sides extending between the first and second ends, securing the first end of said sheet to said unit, wrapping the sides of said sheet around said unit to form a passageway from said unit and securing the second end of said sheet to the surface of said sheet adjacent the second end forming the passageway extending from said unit.
